(19) United States
(12) Patent Application Publication
(10) Pub. No.: US 2011/0030238 A1
(43) Pub. Date: Feb. 10, 2011

(54) VENTED DRYER HAVING REDUCED CONDENSATION FORMATION AND METHOD FOR OPERATING THE SAME

(75) Inventors: Thomas Nawrot, Berlin (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/937,723

(22) PCT Filed: Apr. 7, 2009
(86) PCT No.: PCT/EP2009/054164

§ 371 Date: Oct. 14, 2010

(30) Foreign Application Priority Data
Apr. 24, 2008 (DE) 10 2008 020 556.7

(51) Int. Cl. F26B 11/02

(52) U.S. Cl. 34/499; 34/132

(57) ABSTRACT

A vented dryer having a drum to dry damp laundry by warm process air; a first process air channel upstream of the drum; a heater to heat the process air in the first process air channel; a supply air channel opening into the first process air channel; a second process air channel downstream of the drum; an outlet air channel originating from the second process air channel; a first blower in the first process air channel; and an auxiliary air channel through which auxiliary air is supplied from the environment of the vented dryer. The auxiliary air channel opens into the outlet air channel.

The invention relates to a vented dryer having reduced condensation formation and a method for operating the same.

In a dryer, in particular tumble dryer, laundry disposed in a generally rotating drum is dried by a heated air flow being routed through the drum and thus through the laundry, said heated air flow withdrawing moisture from the damp laundry, as a result of which the laundry is gradually dried.

The supplied air flow (“process air flow”) is heated in a supply line (air supply channel) and/or herein “first process air channel”) upstream of the drum (herein also “laundry drum”) by means of a heating facility and after passing through the laundry in the drum is either discharged outwards (vented dryer) or fed to a heat exchanger, in which the air is cooled down and the moisture appears as condensation. Subsequently, the air flow is fed once again to the heating facility and the drum (air-recycling dryer or condensation dryer). Hybrid forms of vented dryers and air-recycling dryers are likewise known. To convey the air, a blower (process air blower) is generally used, which is embodied in particular as a radial blower and comprises an impeller.

DE 34 19 743 A1 discloses a tumble dryer in which an electrical heating unit provided with an air supply connection is attached in an upper region of the rear wall and an outlet air connection directed to the rear or to the side is arranged in a lower region of the rear wall or side wall. In an embodiment of this dryer, a recirculating part is connected between the heating unit and the air outlet connection, with which recirculating part, a proportion of the air flowing to the air outlet connection can be guided back into the dryer as recirculated air, with a ratio between outlet air and recirculated air being variable.

EP 0 702 105 B1 describes a housing for a blower in a household appliance, in particular in a tumble dyer, which enables a reduction of existing noises and an attenuation of developed noises. The housing comprises a radial blower wheel, which is rotatably integrated in a spiral housing and to which the air is supplied axially, with the spiral housing being separably surrounded by a wall in the form of a cover, adapted to its spiral contour and running at a distance from it, and with means for maintaining the distance being provided.

In the case of a vented dryer, under certain conditions (unfavorable installation in a relatively cold environment), with low ambient temperatures in the outlet air line (generally configured as an outlet air pipe) condensation may be formed when the warm humid outlet air is cooled. This is particularly pronounced in the case of a vented dryer which operates very energy efficiently. In order to minimize the energy consumption, the moisture content of the process air is maximized here by using a high temperature with a small volume flow and if necessary a large proportion of recirculated air. With this very high charging of the process air with moisture, unwanted condensate formation can increasingly occur in the outlet air pipe under specific installation conditions. This may possibly result in consequential damage.

The object of the invention is thus to provide a vented dryer which has less of a tendency to separate condensation in the outlet air which it discharges.

In accordance with the invention, this object is achieved by a vented dryer and by a method having the features of the respective independent claim. Advantageous embodiments of the inventive vented dryer and the inventive method are listed in corresponding dependent claims.

The invention thus relates to a vented dryer having a drum for drying damp laundry by means of warm process air, a heating facility for heating the process air in a first process air channel upstream of the drum, into which an air supply channel opens, a second process air channel downstream of the drum, from which an outlet air channel originates, and a first blower in the first process air channel, with an auxiliary air channel opening into the outlet air channel, by means of which auxiliary air can be supplied from an environment of the vented dryer.

In accordance with the invention, the outlet air laden with moisture is not simply discharged from the vented dryer, but instead ambient air is added to outlet air before this is discharged, in order to reduce its relative moisture content. This effectively reduces the possibility of moisture being condensed out in the outlet air discharged from the dryer. The drying process itself remains unchanged by the addition of auxiliary air to the outlet air.

In accordance with the invention, the relative proportions of process air, which enters into the outlet air channel, and auxiliary air can be selected such that by adding the relatively dry, but in comparison to the process air, colder auxiliary air, despite cooling, a reduction in the relative air moisture results overall and therefore a reduced tendency to form condensation in the mixed air which leaves the vented dryer and is discharged in a known fashion.

The use of an outlet air pipe for discharging the mixed air lies within the scope of the invention, said outlet air pipe either being connected to a permanently installed outlet air system in the building, in which the vented air dryer is installed, or being hung out from a correspondingly opened window, in order to prevent the inner regions of the building from being exposed to moisture from the drying laundry.

A second blower is preferably located in the outlet air channel or in the auxiliary air channel, particularly preferably in the auxiliary air channel.

It is also preferred, in accordance with the invention, for the first blower and the second blower to be located on one shaft of a drive motor, preferably on opposite sides of the drive motor.

The inventive vented dryer can be operated as a pure vented dryer, in which the overall warm humid process air from the drum is routed out of the vented dryer as outlet air. The inventive vented dryer is however preferably operated with a proportion of the air being recirculated.

In a preferred embodiment of the invention, a first end of a recirculating air channel and a second end of the recirculating air channel therefore open into the first process air channel and into the second process air channel respectively. With this vented dryer, the warm humid process air flowing in the outlet air channel is generally cooled down as a result of the supply of relatively cool auxiliary air. A thermal insulation layer is therefore preferably located between the recirculating air channel and the outlet air channel. Very different types of materials can be used for the thermal insulation layer, provided the purpose of an adequate thermal insulation can be realized. A foam made of organic material is particularly suited hereto, in particular a polyurethane, polystyrene, polyethylene or polypropylene foam.

In preferred embodiments of the inventive vented dryer, and as a result of the use of the special impellers discussed below, fluff accumulation in the air paths and in particular on the blower is significantly reduced. Furthermore, the fluff content in the process air can be reduced by a fluff trap including one or more suitable fluff filters. The term “fluff trap” is to be widely interpreted here. For instance the term includes, a cooling facility which may actually exist alongside a fluff filter, which can also be referred to as a heat exchanger or condenser, in which the warm humid air escaping from the drum, which is more or less laden with fluff, is cooled down by exchanging heat with a suitable cooling medium (supply air and/or cool air in an air-air heat exchanger; coolant in the evaporator of a heat pump) and moisture contained in the process air is condensed. The wet cooling facility can also act in the manner of a fluff trap. Furthermore, nets with different mesh sizes can also be used as fluff filters.

In accordance with the invention, it has proven particularly advantageous if, in the embodiment with a recirculating air channel, the vented dryer has a fluff trap in the recirculating air channel. The fluff trap is particularly preferably a labyrinth. In such a labyrinth, the air containing the fluff is guided such that it results in turbulences forming and the separation of fluff The labyrinth is preferably capable of functioning throughout the service life of the vented dryer.

The inventive vented dryer can be operated with or without a heat exchanger for condensing the moisture contained in the warm process air after passing through the drum.

A particularly preferred embodiment of the invention is characterized by a cooling facility for cooling down the process air, which is arranged in the second process air channel. This cooling facility causes moisture to be condensed out of the process air and thus assists with the task of reducing the relative moisture content in the outlet air finally discharged from the dryer. The cooling facility may be an air-air heat exchanger.

The cooling facility and the heating facility are also preferably combined to form a heat pump, with the cooling facility representing a heat sink and the heating facility representing a heat source such that the heat pump pumps heat, which was extracted from the process air in the heat sink, to the heat source, and is fed there to the process air again. In accordance with the basic rules of thermodynamics, this pump process requires a certain use of energy, and in no way occurs without some small energy loss; however the use of a heat pump can make possible a drying process which consumes even less energy. As is known, such a heat pump can be embodied as a compressor heat pump, in which a coolant circulates, which is cyclically evaporated in the cooling facility by receiving heat from the process air and is condensed in the heating facility by outputting heat to the air flow. Adjustments to different temperature levels in the cooling facility and in the heating facility take place by means of a compressor, which also drives the coolant in a closed loop through the heat pump, and by means of a decompression organ. A heat pump which operates by means of a reversible sorption process, a regenerative gas circuit process or the Peltier effect is also conceivable.

In a particularly preferred embodiment of the invention, the first blower comprises an impeller with blades which are straight in the direction of rotation relative to the drum and/or are curved backwards.

This embodiment is particularly advantageous in the case of an inventive vented dryer with a proportion of recirculated air. In the case of a blower which is used conventionally in a dryer, the impeller has curved blades for an optimal forward air volume flow (i.e. in the running direction). In the case of a dryer, in which the blower is coupled to a drive motor, and the drum of which is reversed, an impeller with straight blades and a symmetrical spiral geometry is also frequently used, in order to realize the same size of air volume flows for both rotational directions. The blower with forwards (i.e. running direction) curved blades is certainly more easily prone to contamination, particularly if the blower is used to convey process air containing fluff, as is the case with an vented dryer having a proportion of recirculated air.

In the first blower of the inventive vented dryer, the impeller therefore particularly preferably comprises backwards curved blades in the running direction. It is particularly preferred here for the impeller to consist of blades curved backwards in the running direction. This impeller generally consists of metal or plastic, preferably plastic. The latter provides for a particularly efficient manufacture, for instance by means of an injection-molding method.

In accordance with the invention, the blading of the impeller may be straight or inclined in the first, but also in the second blower. An oblique blading is preferably used. “Oblique” blading within the meaning of the invention means that the blades of the impeller form an angle with the wheel circumference of the impeller other than 90°. This means that the edge of a blade does not lie in parallel to the rotational axis of the impeller during operation of the blower.

It was surprisingly found that an impeller with an oblique blading results in a significant noise reduction compared with an otherwise identical impeller with straight blading. This applies in particular in the case of small distances between the blades of the impeller, in guides of the blower housing, since sounds can in this instance be heard and measured particularly easily. The realization of small distances between the guide and blades and/or impeller is however an essential means for increasing the output as a result of the generally restricted installation space in blowers, which are to be as small as possible.

The inventive vented dryer and the blower used therein can also contain sound attenuation components, as are described for instance in the publication EP 0702 105 B1. Furthermore, the further sound attenuation measures likewise described in publication EP 0702 105 B1 can be used. Examples of this are a double wall of the spiral housing of the blower and a minimization of the number of sound bridges, a perforation of the spiral casing and the configuration of intermediate spaces with insulating material.

The subject matter of the invention is also a method for operating a vented dryer, having a drum for drying damp laundry by means of warm process air, a heating facility for heating the process air in a first process air channel upstream of the drum, into which a supply air channel opens, a second process air channel downstream of the drum, from which an outlet air channel originates, and a first blower in the first process air channel, with an auxiliary air channel opening into the outlet air channel, through which auxiliary air is supplied from an environment of the vented dryer, with the auxiliary air being added to the process air laden with moisture and entering the outlet air channel.

In a preferred embodiment of this method, after auxiliary air is supplied from the auxiliary air channel, a volume ratio of process air laden with moisture relative to auxiliary air amounts in the outlet air channel to 1.5 to 5, in particular to 2 to 4.

In the inventive vented dryer, the tendency to separate condensation in the outlet air channel is significantly reduced. Here the inventive vented dryer is advantageous in that the condensation of moisture can be significantly reduced or prevented even with unfavorable installation conditions. In embodiments the vented dryer is considerably less susceptible to dirt when implementing a drying method, in particular air paths and blower of the vented dryer. The advantages of the invention are particularly pronounced in the case of a vented dryer having a proportion of recirculated air, which does not contain a heat exchanger for condensing moisture contained in the warm process air.

Moreover, with an inventive vented dryer having a blower with an obliquely bladed impeller (“impeller with oblique blading”), it is advantageous that compared with the case having a straight bladed impeller, an impeller with a larger diameter can be used, without the noise level increasing. A higher power output of the blower can be realized without increasing the noise level.

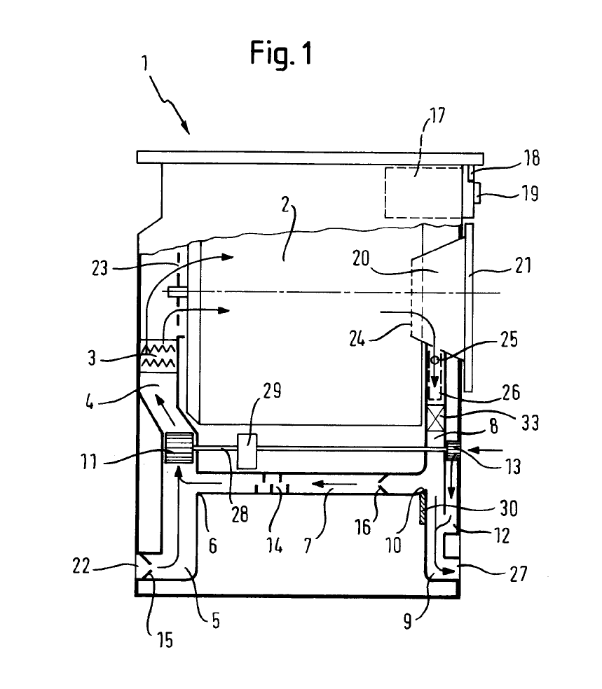

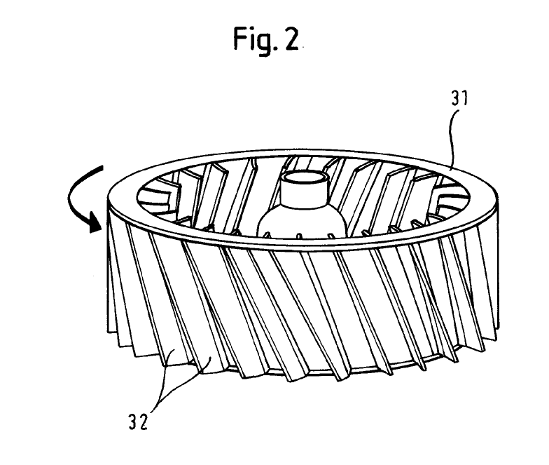

Further details of the invention result by reference to the FIGS. 1 and 2 from the subsequent description of a non-restrictive exemplary embodiment.

FIG. 1 shows a part sectional view of a vented dryer.

FIG. 2 shows an impeller with oblique blading, which is used in a preferred embodiment of the vented dryer.

FIG. 1 shows a part sectional view of a vented dryer 1. This has a program control facility 17 in its upper part, which can be adjusted by a control knob 19. A display apparatus 18 for different statuses of the vented dryer 1 is likewise provided.

The vented dryer 1 comprises a drum 2, which is accessible from a loading door 21 by way of a pot 20, and by way of which laundry items to be dried can be introduced into the drum 2 and removed again.

There is a process air opening 22 on the rear of the laundry dryer 1, into which air is sucked from the outside by way of a first blower 11 and routed into a first process air channel 4. The fresh process air (also referred to as “supply air”) flows from the first process air channel 4, via a heating facility 3 to the input 23 of the drum 2. The process air traverses the drum 2 and flows at the output 24 through a second process air channel 8. A temperature sensor 25 is arranged behind the drum 2 in the second process air channel 8, said temperature sensor 25 periodically detecting the temperature of the process air at predetermined time intervals and feeding the measured value to the program control facility 17.

A fluff sieve 26 is located in the second process air channel 8. The process air flows through the second process air channel 8, which divides into a recirculating air channel 7 and an outlet air channel 9. Part of the process air from the drum 2 thus reaches an outlet air exit 27 via the outlet air channel 9, from where process air flows into the installation space of the vented dryer as outlet air. The remaining part of the process air flows through the recirculating air channel 7, in which a labyrinth 15 is arranged as a fluff collector, via the first blower 11 and the heating facility 3 back into the drum 2. The vented dryer 1 of this embodiment thus operates according to an outlet air principle with a proportion of recirculated air.

A cooling facility 33, which is only shown schematically, is located in the second process air channel 8 behind the actual fluff sieve 26. This may be an air-air heat exchanger 33, which is fed air from the environment of the dryer 1, as cooling air. The cooling facility 33 can also be joined to the heating facility 3 in a heat pump 3, 33 such that the heat pump pumps heat, which was withdrawn from the process air as a heat sink 33 in the cooling facility 33, to the heating facility 3 functioning as heat source 3 and is fed there again to the process air. In accordance with the basic rules of thermodynamics, this pump process requires a certain use of energy, and in no way occurs without some small energy loss. However the use of a heat pump 3, 33 can also make possible a drying process which consumes even less energy. As is known, such a heat pump 3, 33 can be embodied as a compressor heat pump, in which a coolant circulates, which is cyclically evaporated in the cooling facility 33 by receiving heat from the process air and is condensed in the heating facility 3 by outputting heat to the air flow. The adjustment to different temperature levels in the cooling facility 33 and in the heating facility 3 takes place by means of a compressor, which also drives the coolant in a closed circuit through the heat pump 3, 33 and by means of a decompression organ. A heat pump which operates by means of a reversible sorption process, a regenerative gas circuit process or the Peltier effect is also conceivable. Further components of the heat pump 3, 33 are not shown for the sake of clarity.

In the embodiment of the vented dryer shown in FIG. 1, the relative proportions of supply air and recirculating air can be adjusted in the recirculating air channel 7 by way of a first valve 15 or a first flap 15 in the supply air channel 5 and a second valve 16 or a second flap 16.

An auxiliary air channel 12 opens into the outlet air channel 9, in which air (auxiliary air) is sucked out of the installation space of the vented dryer, with the aid of a second blower 13, and is routed into the outlet air channel 9. It is mixed there with the proportion of the warm humid process air which is not routed into the recirculating air channel 7 but instead into the outlet air channel 9.

The relative proportions of process air, which enter into the outlet air channel, and auxiliary air are selected in such cases such that by adding the relatively dry, but in comparison to this process air, cold auxiliary air, a reduction in the relative air humidity and thus a reduced tendency to condensation formation occur overall despite a cooling process.

In the embodiment of the vented dryer shown in FIG. 1, the first blower 11 and the second blower 13 are arranged on a shaft 28 of a motor 29. The first blower 11 and second blower 13 are disposed on opposite sides of the motor 29 in this preferred embodiment.

FIG. 2 shows an impeller used in a preferred embodiment of the vented dryer, having an oblique blading. 32 indicates a backwards curved blade. 31 indicates the impeller. The arrow shows the running direction of the impeller in the blower.

1-17. (canceled)

18. A vented dryer, comprising:
a drum to dry damp laundry by warm process air;
a first process air channel upstream of the drum;
a heater to heat the process air in the first process air channel;
a supply air channel opening into the first process air channel;
a second process air channel downstream of the drum;
an outlet air channel originating from the second process air channel;
a first blower in the first process air channel; and
an auxiliary air channel through which auxiliary air is supplied from the environment of the vented dryer, the auxiliary air channel opening into the outlet air channel.

19. The vented dryer of claim 18, further comprising a second blower in one of the outlet air channel and the auxiliary air channel.

20. The vented dryer of claim 19, wherein the second blower is in the auxiliary air channel.

21. The vented dryer of claim 19, further comprising a drive motor having a shaft, wherein the first blower and the second blower are on the shaft of the drive motor.

22. The vented dryer of claim 18, further comprising a recirculating air channel having a first end that opens into the first process air channel and a second end that opens into the second process air channel.

23. The vented dryer of claim 22, further comprising a thermal insulation layer between the recirculating air channel and the outlet air channel.

24. The vented dryer of claim 22, further comprising a fluff trap in the recirculating air channel.

25. The vented dryer of claim 24, wherein the fluff trap is a labyrinth.

26. The vented dryer of claim 18, further comprising a cooler in the second process air channel to cool the process air.

27. The vented dryer of claim 26, further comprising a heat pump formed by the cooler and the heater, wherein the cooler is joined to the heater.

28. The vented dryer of claim 18, wherein the first blower has an impeller that has, in a running direction of the impeller, at least one of straight and backwards curved blades relative to the drum.

29. The vented dryer of claim 28, wherein the impeller has backwards curved blades in the running direction.

30. The vented dryer of claim 28, wherein the impeller is made of plastic.

31. The vented dryer as of claim 28, wherein the impeller has oblique blading.

32. The vented dryer of claim 28, wherein the impeller has straight blading.

33. A method for operating a vented dryer having a drum to dry damp laundry by warm process air; a first process air channel upstream of the drum; a heater to heat the process air in the first process air channel; a supply air channel opening into the first process air channel; a second process air channel downstream of the drum; an outlet air channel originating from the second process air channel; a first blower in the first process air channel; and an auxiliary air channel through which auxiliary air is supplied from the environment of the vented dryer, the method comprising:
mixing the auxiliary air from the auxiliary air channel with moisture-laden process air entering into the outlet air channel.

34. The method of claim 33, wherein a volume ratio of the moisture-laden process air to the auxiliary air is 1.5 to 5 in the outlet air channel after the auxiliary air has been supplied from a drying channel.
